(19) United States
(12) Patent Application Publication
(10) Pub. No.: US 2001/0047623 A1
(43) Pub. Date: Dec. 6, 2001

(54) METHOD OF COMBUSTION, ESPECIALLY FOR THE PRODUCTION OF PIG IRON OR FOR THE MANUFACTURE OF CEMENT

(76) Inventors: IVAN MILOSAVLJEVIC, PARIS CEDEX (FR); PASCAL DUPERRAY, PARIS CEDEX (FR); STEPHANE ARNOUX, PARIS CEDEX (FR)

Correspondence Address: BURNS DOANE SWECKER & MATHIS L L P, POST OFFICE BOX 1404, ALEXANDRIA, VA, 22313-1404, US

(21) Appl. No.: 09/440,291

(22) Filed: Nov. 15, 1999

(30) Foreign Application Priority Data
Nov. 20, 1998 (FR) 98 14658

(51) Int. Cl. C01B 3/12; F23G 5/00

(52) U.S. Cl. 48/197 R; 48/197 FM; 110/235; 110/346

(57) ABSTRACT

The invention relates to a method of combustion, in which waste, especially household and/or industrial waste, is subjected to a process (T) comprising at least one step in which the waste is pyrolysed and a gas mixture containing hydrocarbons is created, and then a step in which gaseous hydrocarbons are brought into contact with steam and with an oxidizing agent, and resulting in the production of a final gas mixture (FM) containing carbon monoxide and hydrogen, and then at least part of the carbon monoxide and of the hydrogen is used, as a mixture, as fuel, for example in a blast furnace (F) or in a cement kiln.

The method can be used especially for manufacturing pig iron or cement.

The invention relates to a method of combustion, especially for the production of pig iron in a blast furnace, for the purpose more particularly of reducing the consumption of coke in such a process, without affecting the quality of the pig iron produced, or else for the manufacture of cement in a cement kiln.

Processes for producing pig iron in blast furnaces are already known, in which, in order to reduce the consumption of coke, an auxiliary fuel, such as pulverized coal, tar, fuel oil, natural gas or coke-oven gas, is injected into the combustion zone of the blast furnace, then a smelting reduction of the iron ore and of the fluxes is conventionally carried out using the heat and the reducing gases obtained by the combustion of the coke and of the other fuels and of air preheated to a high temperature, and the carburized liquid iron (pig iron) and a fluid silicate-forming slag, formed from unreduced oxides of the ore gangue, fluxes and coke ash, are collected in a crucible.

Moreover, in quite another field, it is known to partially eliminate waste, especially household and/or industrial waste containing carbon compounds, particularly organic compounds, by pyrolysis; however, this pyrolysis releases a gas mixture, containing an appreciable proportion of hydrocarbons, which, when it is discharged into the atmosphere, contributes significantly to atmospheric pollution; it has therefore been sought to convert this pyrolysis gas containing hydrocarbons; for this purpose, it is subjected to a synthesis process call gasification during which it is brought into contact with steam and with oxygen at a relatively high temperature, and thus all or some of the hydrocarbons are decomposed, the steam is reduced or cracked and the carbon is oxidized, thereby creating carbon monoxide and hydrogen. In the new gas mixture obtained, called “synthesis gas”, the carbon monoxide+hydrogen fraction is combustible and can be used as a fuel.

The object of the invention is to use these teachings aimed at reducing discharge into the atmosphere of polluting substances, so as to reduce the consumption of coke in blast furnaces, or of pulverized coal and/or fuel oil and/or gas in cement kilns.

For this purpose, the invention relates to a method of combustion, characterized in that waste, especially household and/or industrial waste, is subjected to a process comprising at least one step in which the waste is pyrolysed and a gas mixture containing hydrocarbons is created, and then a step in which gaseous hydrocarbons are brought into contact with steam and with an oxidizing agent, and resulting in the production of a final gas mixture containing carbon monoxide and hydrogen, and then at least part of the carbon monoxide and of the hydrogen is used, as a mixture, as fuel.

Advantageously, in order to use at least part of the carbon monoxide and of the hydrogen as a mixture, it is introduced as fuel and reducing agent in a blast furnace where coke is also introduced.

By virtue of the fact that carbon monoxide and hydrogen are introduced as a mixture into the blast furnace, the latter is supplied not only with a supplementary fuel allowing the consumption of coke to be reduced, but also a reducing agent contributing to the reduction of the iron oxides, this being so without having to wait for the kinetics of the endothermic reaction of oxidation of the coke by carbon dioxide formed by combustion to result in the formation within the very blast furnace of carbon monoxide and for this carbon monoxide to be perfectly distributed within the shaft of the blast furnace.

As an alternative, in order to use at least part of the carbon monoxide and of the hydrogen as a mixture, it is introduced as a fuel into a cement kiln.

The method may also have, depending on the intended use, one or more of the following characteristics:

the said process comprises, at the end of a step in which gaseous hydrocarbons are put into contact with steam and with an oxidizing agent and thus a gas mixture containing carbon monoxide and hydrogen is created, an additional step in which at least one metal belonging to the group consisting of heavy metals is extracted, so as to create a final gas mixture free of this metal;

the waste is pyrolysed in the pyrolysis step at a temperature of at least equal to approximately 300° C.;

in the step in which gaseous hydrocarbons are brought into contact with steam and with an oxidizing agent, the temperature of the hydrocarbons is raised, the carbon of these hydrocarbons is isolated, the steam is decomposed in order to obtain oxygen, and a synthesis of carbon and of oxygen is carried out in order to obtain at least carbon monoxide and hydrogen;

a final gas mixture, at least approximately half of which consists of a mixture of carbon monoxide and hydrogen, is produced;

a final gas mixture is produced which contains hydrogen and carbon monoxide with a hydrogen/carbon monoxide ratio of approximately 0.5 to 3, and preferably contains approximately the same amount of hydrogen and carbon monoxide;

a mixture of carbon monoxide and hydrogen is introduced into at least one nozzle of a blast furnace;

a mixture of carbon monoxide and hydrogen is introduced at a high temperature, of the order of 1200° C., into a blast furnace;

it includes a step during which the hydrogen/carbon monoxide ratio of the mixture introduced into blast furnace is adjusted;

at least part of the carbon monoxide and of the hydrogen is introduced as a mixture into a main combustion zone of a cement kiln;

at least part of the carbon monoxide and of the hydrogen is introduced as a mixture into a post combustion zone of a cement kiln;

at least part of the carbon monoxide and of the hydrogen is introduced as a mixture into a “Lepol” grate zone of a cement kiln;

at least part of the carbon monoxide and of the hydrogen is introduced as a mixture into a cement kiln via a dedicated injection means;

at least part of the carbon monoxide and of the hydrogen is introduced as a mixture into a cement kiln by injecting it into the flame of a main burner;

at least part of the carbon monoxide and of the hydrogen as a mixture and oxygen are introduced into the cement kiln; and

at least part of the carbon monoxide and of the hydrogen as a mixture and oxygen are introduced into the cement kiln via the same injection means.

Further characteristics and advantages of the invention will emerge from the description which follows of a non-limiting example of the method according to the invention, illustrated in the appended drawings in which:

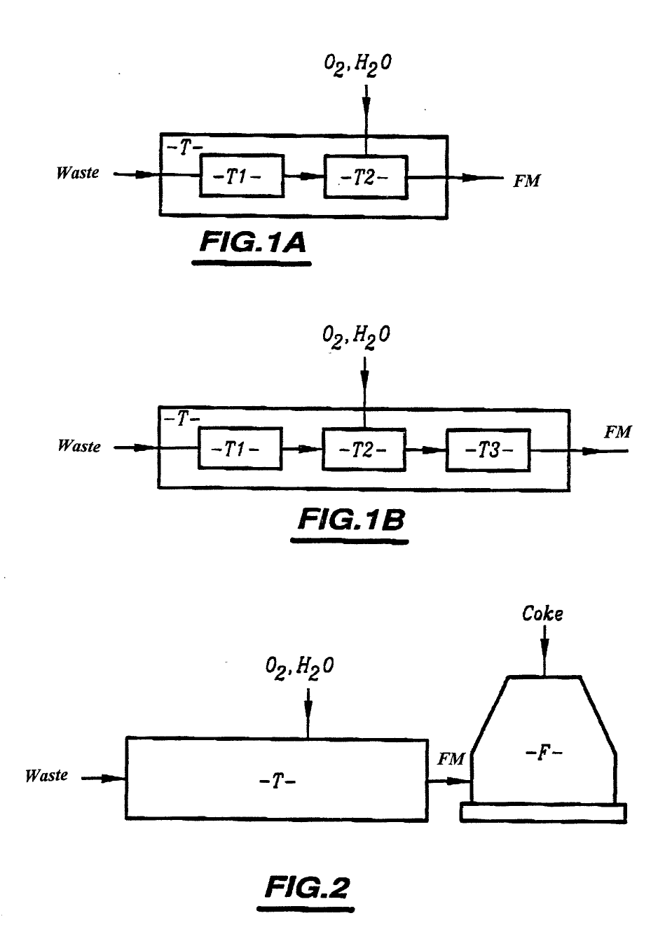

FIG. 1a is a block diagram of a waste treatment process resulting in the production of a combustible gas used in a method according to the invention;

FIG. 1b is a block diagram of an alternative form of the process in FIG. 1a; and

FIG. 1c is a block diagram of a method according to the invention.

The method illustrated in these figures starts with a process T in which waste, for example household waste and/or industrial waste, is treated and a final gas mixture FM containing carbon monoxide and hydrogen is produced, and the method is completed by the combustion of the gas mixture, for example by introducing it into a blast furnace where coke is also introduced, or else into a cement kiln.

The steps of the waste-treatment process T (FIGS. 1a and 1b) are chosen depending on the nature of the waste, so that a final gas mixture FM is obtained which is sufficiently rich in carbon monoxide and in hydrogen and is free of product harmful for the intended use, in this case for the production of pig iron.

In order to obtain a final gas mixture FM relatively rich in hydrogen and in carbon monoxide without excessive loss, for example a mixture of which at least approximately half consists itself of a mixture in which the hydrogen/carbon monoxide ratio is approximately 0.5 to 3, and preferably approximately equal to 1, it is desirable to start with waste rich in carbon and in hydrogen, for example rich in organic matter.

Under these conditions, the waste is pyrolysed in a first step T1 of the treatment process T and a first gas mixture called pyrolysis gas containing an appreciable proportion of hydrocarbons in a gaseous state is released. Preferably, the pyrolysis is carried out at at least approximately 300° C. for a few hours; of course, it is possible to carry out the process more rapidly, at a higher temperature.

In a second step T2, known by the name of gasification, the mixture containing hydrocarbons in the gaseous state (pyrolysis gas) is converted into a second gas mixture containing carbon monoxide and hydrogen. In general, in this step T2, the temperature of the first gas mixture is raised to a relatively high temperature and the first gas mixture is brought into contact with steam and with an oxidizing agent (for example oxygen or air optionally enriched with oxygen); in this way, all or part of the hydrocarbons in the gaseous state are decomposed, that is to say the carbon is isolated, and the steam is cracked or reduced, thereby releasing oxygen from the latter, and the synthesis of carbon and oxygen is carried out under the conditions allowing mainly carbon monoxide to be obtained. By means of the oxygen (or more generally of the oxidizing agent) which is also introduced in addition to the steam, the endothermic synthesis reaction is initiated and maintained, by virtue of the temperature hold provided by the oxygen.

This second gas mixture, if it meets the abovementioned conditions, is preferably the final gas mixture FM which is introduced into the blast furnace (FIG. 1a) directly at its high temperature, namely approximately 1200° C. in general.

If this is not the case (FIG. 1b), it may be subjected to at least one additional step T3 by means of which it is enriched with carbon monoxide and with hydrogen, and/or the harmful products are removed therefrom; this is especially the case if the second gas mixture contains vapours of heavy metals, especially zinc; in this situation, in the step T3 for treating the second gas mixture, these heavy metals are extracted and a third gas mixture is obtained, the final gas mixture FM.

However, it may be noted that this final gas mixture may contain certain impurities, for example steam and/or carbon dioxide.

The final gas mixture FM, whether it consists of the synthesis gas obtained after the gasification step T2 or of the gas coming from an additional step T3, is sent preferably at high temperature, for example approximately 1200° C., into the blast furnace F, and more specifically into at least one nozzle of the latter (which generally terminates, in a known manner, in a crucible), into which blast furnace coke is also introduced in a known manner, usually together with iron ore and a flux (castine, dolomite or the like).

The advantage of the method according to the invention is clear since it makes it possible, on the one hand, to reduce discharge into the atmosphere of gaseous hydrocarbons emitted during the combustion of the waste and, on the other hand, to reduce the cost of manufacturing the pig iron appreciably.

Specifically, the production of pig iron in a blast furnace uses approximately 500 kg of coke per tonne of pig iron; by replacing 15% of the coke with the final gas mixture coming from the process described above, 2400 MJ per tonne of pig iron is needed, thereby requiring 300 kg of the final gas mixture per tonne of pig iron.

However, the process for manufacturing the final gas mixture makes it possible to obtain approximately 900 kg of gas mixture from one tonne of waste (and 500 kg of oxygen) and the electrical equivalent of these 900 kg of gas mixture may be estimated to be 340 kW.h, corresponding to a sum A (selling price of these 340 kW.h by an electrical energy distributor); as a result, the use of 300 kg of gas mixture per tonne of pig iron amounts to A/3 per tonne of pig iron.

However, the reduction in consumption of coke results in a saving B per tonne of pig iron, presently significantly greater than A/3.

The overall saving is therefore B-A/3 per tonne of pig iron and, under the present conditions, the amortization of the plant for carrying out the process resulting in the manufacture of the final gas mixture is sufficiently rapid to allow widely beneficial exploitation of the method.

Of course, the invention is not limited to the above embodiments that have been described and illustrated, and other embodiments thereof may be provided without departing from its scope; in particular, the hydrogen/carbon monoxide proportion may be adjusted by intervening, for example, in the gasification step T2 and/or in the possible additional step T3 and/or by carrying out a suitable treatment in another additional step that is implemented after the step T2 and, if there is one, before or after the step T3.

In particular, it is convenient to adapt the steps of the process T in order to obtain a final gas mixture compatible with the desired use, which process may be, as a variant, for example a combustion process by introducing the gas mixture into a cement kiln into which pulverized coal and/or fuel oil and/or gas are also introduced.

If the final gas mixture (or at least part of the carbon monoxide and of the hydrogen as a mixture) is intended to feed a cement kiln, the mixture may be injected into the main combustion zone of the kiln and/or into another zone of the kiln, such as a possible post combustion zone and/or zone of the grate known in the art by the name of “Lepol grate”, by means of one or more lances and/or one or more burners “dedicated” to this mixture. In the main combustion zone, the mixture may be injected directly into the flame of the main burner. It is possible to combine the injection of the mixture with an injection of oxygen mixed with air, in order to “enrich” the latter, or of pure oxygen, either separately or jointly via the same injection means.

1. Method of combustion, characterized in that waste, especially household and/or industrial waste, is subjected to a process (T) comprising at least one step (T1) in which the waste is pyrolysed and a gas mixture containing hydrocarbons is created, and then a step (T2) in which gaseous hydrocarbons are brought into contact with steam and with an oxidizing agent, and resulting in the production of a final gas mixture (FM) containing carbon monoxide and hydrogen, and then at least part of the carbon monoxide and of the hydrogen is used, as a mixture, as fuel.

2. Method according to claim 1, characterized in that, in order to use at least part of the carbon monoxide and of the hydrogen as a mixture, it is introduced as fuel and reducing agent in a blast furnace (F) where coke is also introduced.

3. Method according to claim 1, characterized in that the process (T) comprises, at the end of a step (T2) in which gaseous hydrocarbons are put into contact with steam and with an oxidizing agent and thus a gas mixture containing carbon monoxide and hydrogen is created, an additional step (T3) in which at least one metal belonging to the group consisting of heavy metals is extracted, so as to create a final gas mixture (FM) free of this metal.

4. Method according to claim 1, characterized in that the waste is pyrolysed in the pyrolysis step (T1) at a temperature at least equal to approximately 300° C.

5. Method according to claim 1, characterized in that, in the step (T2) in which gaseous hydrocarbons are brought into contact with steam and with an oxidizing agent, the temperature of the hydrocarbons is raised, the carbon from these hydrocarbons is isolated, the water is decomposed in order to obtain oxygen, and a synthesis of carbon and of oxygen is carried out in order to obtain at least carbon monoxide and hydrogen.

6. Method according to claim 1, characterized in that a final gas mixture (FM), at least approximately half of which consists of a mixture of carbon monoxide and hydrogen, is produced.

7. Method according to claim 1, characterized in that a final gas mixture (FM) is produced which contains hydrogen and carbon monoxide with a hydrogen/carbon monoxide ratio of approximately 0.5 to 3, and preferably contains approximately the same amount of hydrogen and carbon monoxide.

8. Method according to claim 1, characterized in that a mixture of carbon monoxide and hydrogen is introduced into at least one nozzle of a blast furnace (F).

9. Method according to claim 1, characterized in that a mixture of carbon monoxide and hydrogen is introduced at a high temperature, of the order of 1200° C., into a blast furnace.

10. Method according to claim 1, characterized in that it includes a step during which the hydrogen/carbon monoxide ratio of the mixture introduced into a blast furnace is adjusted.

11. Method according to claim 1, characterized in that, in order to use at least part of the carbon monoxide and of the hydrogen as a mixture, it is introduced as a fuel into a cement kiln.

12. Method according to claim 11, characterized in that at least part of the carbon monoxide and of the hydrogen is introduced as a mixture into a main combustion zone of a cement kiln.

13. Method according to claim 11, characterized in that at least part of the carbon monoxide and of the hydrogen is introduced as a mixture into a post combustion zone of a cement kiln.

14. Method according to claim 11, characterized in that at least part of the carbon monoxide and of the hydrogen is introduced as a mixture into a “Lepol” grate zone of a cement kiln.

15. Method according to claim 11, characterized in that at least part of the carbon monoxide and of the hydrogen is introduced as a mixture into a cement kiln via a dedicated injection means.

16. Method according to claim 11, characterized in that at least part of the carbon monoxide and of the hydrogen is introduced as a mixture into a cement kiln by injecting it into the flame of a main burner.

17. Method according to claim 11, characterized in that at least part of the carbon monoxide and of the hydrogen as a mixture and oxygen are introduced into the cement kiln.

18. Method according to claim 11, characterized in that at least part of the carbon monoxide and of the hydrogen as a mixture and oxygen are introduced into the cement kiln by the same injection means.
